(19) United States
(12) Patent Application Publication
(10) Pub. No.: US 2020/0177675 A1
(43) Pub. Date: Jun. 4, 2020

(54) COMMUNICATION DEVICE AND METHOD OF CONTROLLING SAME

(71) Applicant: CANON KABUSHIKI KAISHA, Tokyo (JP)

(72) Inventor: Naoya Tamura, Niigata-shi (JP)

(21) Appl. No.: 16/693,142

(22) Filed: Nov. 22, 2019

(30) Foreign Application Priority Data
Nov. 29, 2018 (JP) 2018-223219

(51) Int. Cl. H04L 29/08; H04W 48/16; H04W 8/00

(52) U.S. Cl. CPC H04L 67/1068; H04L 67/36; H04W 8/005; H04W 48/16

(57) ABSTRACT

A communication device includes a first obtaining unit that searches for another communication device that does not belong to a wireless network to which the communication device belongs without using an access point of the wireless network, and obtains first search information for establishing a connection in a first connection mode or a second connection mode different from the first connection mode; a second obtaining unit that searches for the another communication device via the access point of the wireless network, and obtains second search information for establishing a connection in the second connection mode; a first connection unit that establishes a connection in the first connection mode with the another communication device without using the access point of the wireless network; and a second connection unit that establishes a connection in the second connection mode with the another communication device via the access point of the wireless network.

### BACKGROUND

### Field of the Disclosure

The present disclosure relates to a communication device and a method of controlling the same.

### Description of the Related Art

Miracast®, which is wireless communication transmission technology, supports not only a peer-to-peer connection using Wi-Fi Direct, but also communication over an infrastructure mode connection via a wireless access point, which is a new standard (Japanese Patent Laid-open No. 2016-54407). In Miracast wireless communication, a device that transmits video (moving image) streaming is called a source, and a device that receives the video streaming is called a sink. Wi-Fi Display is known as video streaming technology used in Miracast wireless communication. Wi-Fi Display is wireless direct streaming technology standardized by Wi-Fi Alliance®. Hereinafter, Wi-Fi Display will be abbreviated as “WFD”. In addition, peer-to-peer connection will be abbreviated as “P2P connection” or “wireless P2P connection”, and access point as “AP”.

Multicast DNS (hereinafter abbreviated as “mDNS”) is known as technology for finding services provided on and devices connected to a local link network. To establish an infrastructure mode connection, a WFD transmitting device (source) uses mDNS to search for a WFD receiving device (sink), and obtains port number information. The WFD transmitting device transmits, as a connection request for the WFD receiving device found by the search, an R2 command for establishing a WFD session over a TCP connection, thereby establishing a connection with the WFD receiving device. A search using mDNS is a method of conducting a search by multicasting a search condition using User Datagram Protocol (UDP), and a device that satisfies the condition sends a response. DNS is short for Domain Name System. TCP is short for Transmission Control Protocol.

To establish a P2P connection, one device serving as an AP becomes a group owner (hereinafter abbreviated as “GO”), and forms a group. Another or other devices participate in that group as clients, thereby establishing a connection. A search using P2P is a method of conducting a search by sending a probe request to make an inquiry, and a client device that has received the inquiry sends a probe response.

Both infrastructure mode connection and P2P connection have, as use cases, connection forms that perform one-to-many communication, as in multi-source and multi-sink.

Multicast communication based on UDP, which includes a search packet using mDNS, is unable to communicate across subnets. Therefore, no search packet reaches a device that belongs to a network of a different subnet, and, with a Miracast infrastructure mode connection using mDNS, it is unlikely to find a WFD receiving device that belongs to a different subnet. In such a case, because information used in establishing a WFD session may not be obtained, streaming communication over an infrastructure mode connection may not be started.

When a WFD transmitting device and a WFD receiving device are physically close enough to each other to form a P2P group, streaming communication over a P2P connection may be performed. However, because a P2P connection in a connection form (multi-source or multi-sink) that performs one-to-many communication allows streaming communication between client devices via a GO device, if the GO device leaves a network due to power interruption or the like, streaming communication between the client devices is also disrupted.

### SUMMARY

Therefore, in some circumstances, an infrastructure mode connection is preferable to a P2P connection. It is an object of various embodiments to provide a communication device capable of performing wireless communication between communication devices that belong to different wireless networks in a more stable manner.

To achieve the above-described object, some embodiments of a communication device include: a first obtaining unit that searches for another communication device that does not belong to a wireless network to which the communication device belongs without using an access point of the wireless network, and obtains first search information for establishing a connection in a first connection mode or a second connection mode different from the first connection mode: a second obtaining unit that searches for the another communication device via the access point of the wireless network, and obtains second search information for establishing a connection in the second connection mode; a first connection unit that establishes a connection in the first connection mode with the another communication device without using the access point of the wireless network; a second connection unit that establishes a connection in the second connection mode with the another communication device via the access point of the wireless network: and a selecting unit that selects the first connection unit or the second connection unit based on at least one of the first search information and the second search information.

And some embodiments of a communication device include: a first connection unit that establishes a connection in a first connection mode with another communication device that does not belong to a wireless network to which the communication device belongs without using an access point of the wireless network; a second connection unit that establishes a connection with the another communication device in a second connection mode different from the first connection mode via the access point of the wireless network; and a transmitting unit that, in a case of responding to a search received from the another communication device without using the access point of the wireless network, transmits information for establishing a connection in the second connection mode to the another communication device.

Further features of various embodiments will become apparent from the following description of exemplary embodiments with reference to the attached drawings.

### BRIEF DESCRIPTION OF THE DRAWINGS

FIG. 1 is a diagram illustrating an exemplary network configuration in an example embodiment.

FIG. 2 is a block diagram that schematically illustrates the configuration of a WFD transmitting/receiving device in the embodiment.

FIG. 3 is a sequence diagram when a WFD transmitting device connects to a WFD receiving device.

FIG. 4 is a flowchart illustrating a process of transmitting a probe response from a P2P search unit.

FIG. 5 is a diagram illustrating the format of WFD IE.

FIG. 6 is a flowchart for describing a process performed by a connection selecting unit.

### DESCRIPTION OF THE EMBODIMENTS

Hereinafter, embodiments will be described in detail with reference to the accompanying drawings. Note that the following embodiments are not construed to limit all embodiments, and all combinations of features described in the embodiments are not necessarily required for the solution in every embodiment. The configuration of the embodiments may be modified or changed according to the specification or various conditions (usage conditions, usage environment, etc.) of a device to which the present disclosure is applied. It shall be noted that the technical scope of the claims is not limited by the following embodiments. Although a wireless communication device using Miracast will be described in the embodiments as an example of a communication device, in some embodiments a communication device is not limited to such a wireless communication device.

### About Network Configuration

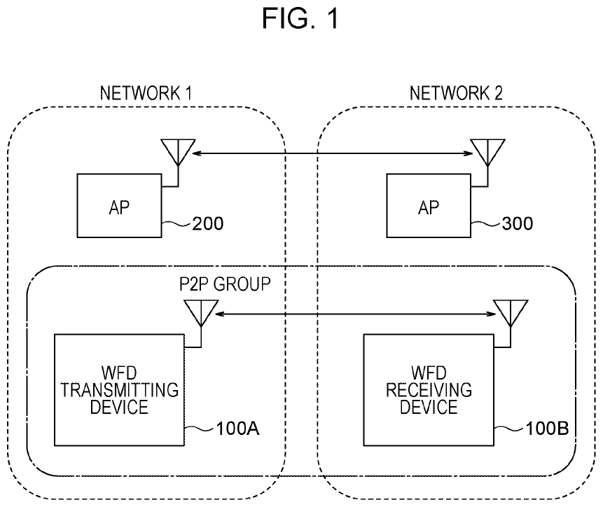

FIG. 1 is a diagram illustrating an exemplary network configuration in an example embodiment.

In the present embodiment, the case will be described in which a WFD transmitting device 100A conducts both an mDNS search and a P2P search, and finds a WFD receiving device 100B by both searches.

The WFD transmitting device 100A, together with an access point (AP) 200, forms a wireless network 1, and the WFD receiving device 100B, together with an AP 300, forms a wireless network 2. The wireless network 1 and the wireless network 2 are subnetworks; the WFD transmitting device 100A does not belong to the wireless network 2, and the WFD receiving device 100B does not belong to the wireless network 1.

The AP 200 and the AP 300 are capable of communicating with each other. This enables the WFD transmitting device 100A and the WFD receiving device 100B to communicate with each other over an infrastructure mode connection. Therefore, the WFD transmitting device 100A is able to transmit data to the WFD receiving device 100B, which is a wireless communication device that does not belong to the wireless network 1 to which the WFD transmitting device 100A belongs, over an infrastructure mode connection.

In the present embodiment, the WFD transmitting device 100A and the WFD receiving device 100B are physically close to each other and are thus able to form a P2P group. This allows the WFD transmitting device 100A and the WFD receiving device 100B to also perform streaming communication over a wireless P2P connection. That is, the WFD transmitting device 100A is capable of connecting to the WFD receiving device 100B in the infrastructure mode, which is one connection mode, and is also capable of connecting to the WFD receiving device 100B over a wireless P2P connection, which is another connection mode.

The WFD transmitting device 100A is, for example, a PC, a tablet terminal, a camera, or a mobile terminal (such as a smartphone), and is a wireless communication device that functions as a source conforming to the WFD standard. PC is an abbreviation for personal computer.

The WFD receiving device 100B is, for example, a television (TV), a display, a projector, a printer, a digital camera, a mobile terminal, or a tablet terminal, and is a wireless communication device that mainly has an output unit, such as a display unit, and that functions as a sink conforming to the WFD standard.

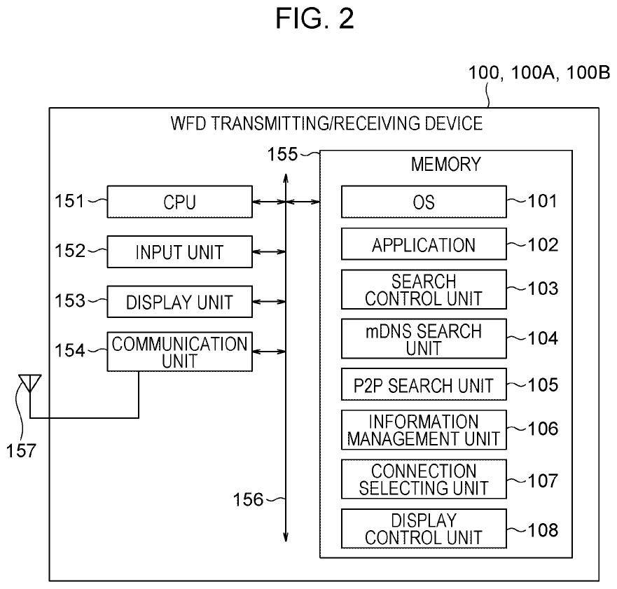

The WFD transmitting device 100A displays video stored in its memory 155 (FIG. 2) on its display unit (screen) 153 (FIG. 2), and, at the same time, transmits the video as video data (video stream) to the WFD receiving device 100B. The WFD receiving device 100B receives video data from the WFD transmitting device 100A, and displays the video data on a display unit of the WFD receiving device 100B.

Note that the WFD transmitting device 100A and the WFD receiving device 100B have the same configuration in the present embodiment. When functioning as a device on the source side, the device is called the WFD transmitting device 100A; and when functioning as a device on the sink side, the device is called the WFD receiving device 100B.

Although one WFD transmitting device 100A and one WFD receiving device 100B are illustrated in the network configuration in FIG. 1, the number of WFD transmitting devices 100A and the number of WFD receiving devices 100B are not limited to those illustrated in FIG. 1.

### Configuration of WFD Transmitting/Receiving Device 100

Next, the configuration of a WFD transmitting/receiving device 100 (100A and 100B) according to the present embodiment will be described.

FIG. 2 is a block diagram that schematically illustrates an exemplary configuration of the WFD transmitting/receiving device 100. As described with reference to FIG. 1, when functioning as a device on the source side, the WFD transmitting/receiving device 100 is called the WFD transmitting device 100A; and when functioning as a device on the sink side, the WFD transmitting/receiving device 100 is called the WFD receiving device 100B. The WFD transmitting device 100A and the WFD receiving device 100B have the same block configuration. To distinguish between the WFD transmitting device 100A and the WFD receiving device 100B, A or B is added at the end of a component or a unit included in the device.

The WFD transmitting/receiving device 100 includes, as hardware components, a central processing unit (CPU) 151, an input unit 152, a display unit 153, a communication unit 154, and memory 155. These hardware components 151 to 155 are interconnected by an internal bus 156. The communication unit 154 is connected to an antenna 157.

The CPU 151 controls the entire WFD transmitting/receiving device 100. Note that the CPU 151 may physically include a plurality of CPUs or processors. The input unit 152 is, for example, a keyboard, a mouse, or a touchscreen. A touchscreen may be used as a UI screen of the input unit 152. UI is an abbreviation for user interface. The display unit 153 is, for example, a liquid crystal monitor.

The communication unit 154 is an interface for performing wireless communication using a wireless local area network (LAN) conforming to the IEEE 802.11 standard, and transmits/receives data to/from another wireless communication device. Another wireless communication device may hereinafter be referred to as “another device”.

The memory 155 includes one or more RAMs and ROMs. The memory 155 stores an OS 101, an application 102, a search control unit 103, an mDNS search unit 104, a P2P search unit 105, an information management unit 106, a connection selecting unit 107, and a display control unit 108, which are software components. These software components 101 to 108 are read out to, for example, a RAM, and operate under control of the CPU 151. The memory 155 also stores video data and a connection long. OS is an abbreviation for operating system.

The OS 101 is a function unit that controls the entire WFD transmitting/receiving device 100 and that controls execution of the application 102.

The application 102 is an application for reproducing/transmitting data corresponding to Miracast, and is a function unit that controls the start/end of a connection using wireless communication and that controls streaming communication performed by the WFD transmitting/receiving device 100.

The search control unit 103 controls searches conducted by the mDNS search unit 104 and the P2P search unit 105. When the search control unit 103 functions as a search control unit 103A, the search control unit 103A controls searches for the WFD receiving device 100B conducted by an mDNS search unit 104A and a P2P search unit 105A. When the search control unit 103 functions as a search control unit 103B, the search control unit 103B controls responses made by an mDNS search unit 104B and a P2P search unit 105B in order to respond to searches conducted by the WFD transmitting device 100A.

When the mDNS search unit 104 functions as the mDNS search unit 104A, the mDNS search unit 104A is a function unit that conducts a search using mDNS, which multicasts a search condition (search request) and receives a response corresponding to the search condition. That is, the mDNS search unit 104A searches for the WFD receiving device 100B, which is a communication device that does not belong to the wireless network 1, via the access point 200 of the wireless network 1 to which the WFD transmitting device 100A belongs. The mDNS search unit 104A receives, as a response from the WFD receiving device 100B, search information for establishing a connection in the infrastructure mode.

Also, when the mDNS search unit 104 functions as the mDNS search unit 104B, the mDNS search unit 104B receives a search condition from another device, and, if the search condition is satisfied, transmits a response.

When the P2P search unit 105 functions as the P2P search unit 105A, the P2P search unit 105A is a function unit that conducts a search using P2P, which transmits a probe request and receives a probe response from another device that has received the probe request. That is, the P2P search unit 105A searches for the WFD receiving device 100B, which is a communication device that does not belong to the wireless network 1, without using the access point 200 of the wireless network 1 to which the WFD transmitting device 100A belongs. The P2P search unit 105A receives, as a probe response, search information for establishing a P2P connection or a connection in the infrastructure mode from the WFD receiving device 100B.

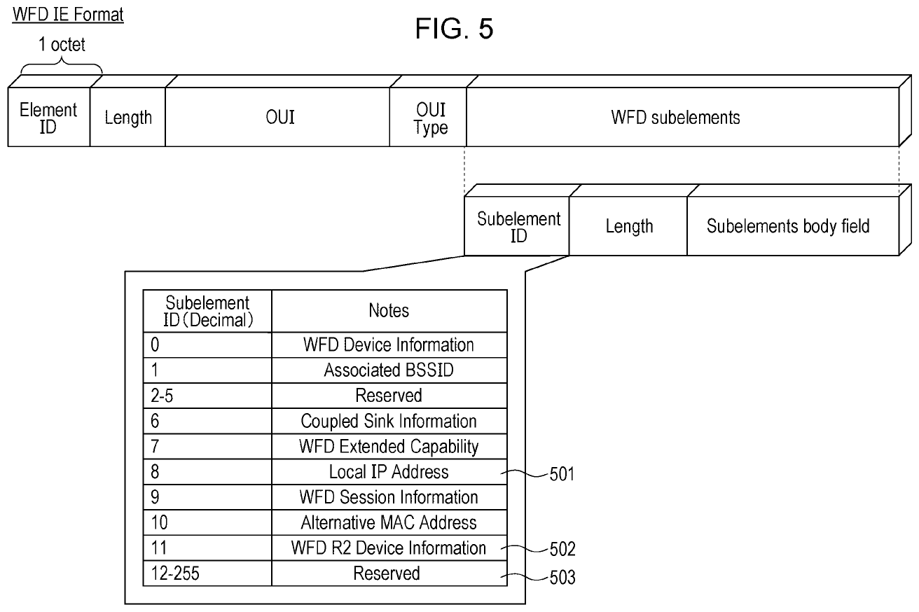

Furthermore, on receipt of a probe response, the P2P search unit 105A checks an extension target area of WFD Information Element (IE). When the checking result indicates that Internet Protocol (IP) address information and port number information are stored in the extension target area of WFD IE, the P2P search unit 105A additionally stores the IP address information and the port number information as information obtained by the search in the information management unit 106. The extension target area of WFD IE will be described later using FIG. 5.

When the P2P search unit 105 functions as the P2P search unit 105B, on receipt of a probe request from another device, the P2P search unit 105B transmits a probe response.

When transmitting a probe response to another device, the P2P search unit 105B determines whether an infrastructure mode connection has been established. When the P2P search unit 105B determines that an infrastructure mode connection has been established, the P2P search unit 105B extends WFD IE as a probe response and adds the IP address information and the port number information of the WFD receiving device 100B. A process of extending WFD IE as a probe response and adding the IP address information and the port number information is called a P2P search response process. Extension of WFD IE will be described later using FIG. 5.

Under control of the search control unit 103, the information management unit 106 manages information regarding another device, obtained by a search conducted by the mDNS search unit 104 or the P2P search unit 105. Information obtained by a search conducted by the mDNS search unit 104 includes, for example, IP address information, device name information, connection enabled/disabled information, and port number information. In addition, information obtained by a search conducted by the P2P search unit 105 may include, for example, device identifier information, device name information, P2P role information, connection enabled/disabled information, and Wi-Fi Protected Setup (WPS) information. When the P2P search unit 105 has extended WFD IE, information obtained by a search conducted by the P2P search unit 105 further includes the IP address information and the port number information.

When the connection selecting unit 107 functions as a connection selecting unit 107A, the connection selecting unit 107A selects, on the basis of search results obtained by the mDNS search unit 104 and the P2P search unit 105, whether to connect to the WFD receiving device 100B over an infrastructure mode connection or a wireless P2P connection, and performs a connection process. More specifically, the connection selecting unit 107A selects an infrastructure mode connection or a wireless P2P connection on the basis of at least one of search information obtained by the mDNS search unit 104A and a search information result obtained by the P2P search unit 105A.

When the connection selecting unit 107 functions as a connection selecting unit 107B, the connection selecting unit 107B performs, in response to a connection request from the WFD transmitting device 100A, a connection process with the WFD transmitting device 100A over either an infrastructure mode connection or a wireless P2P connection.

The display control unit 108 controls the display unit 153 in order to display a streaming image.

Note that this embodiment of the WFD transmitting/receiving device 100 only needs to include at least the configuration illustrated in FIG. 2, and some embodiments may include other hardware components or function units. For example, the WFD transmitting/receiving device 100 may include an audio output unit and a light-emitting unit.

The configuration of the memory 155 illustrated in FIG. 2 is only exemplary; a plurality of function units may be integrated as one function unit, or any of the function units may be divided into a plurality of function units. In addition, one or more function units in the memory 155 may be configured with hardware (e.g., may be realized with a circuit that realizes one or more functions (such as an ASIC)). ASIC is an abbreviation for application specific integrated circuit.

### About Search Process

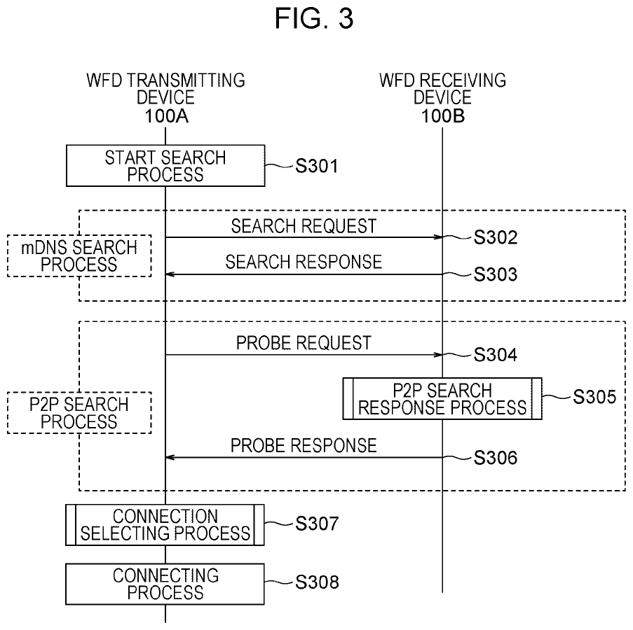

FIG. 3 is a sequence diagram illustrating a process of establishing a connection with the WFD receiving device 100B by conducting a search by the mDNS search unit 104A and the P2P search unit 105A under control of the search control unit 103A included in the WFD transmitting device 100A. In response to a command from the application 102A, the search control unit 103A of the WFD transmitting device 100A starts a process of searching for the WFD receiving device 100B in order to perform streaming communication (S301).

The search control unit 103A gives a command to the mDNS search unit 104A to start a search using mDNS. The mDNS search unit 104A included in the WFD transmitting device 100A multicasts a search request (S302).

On receipt of the multicast search request, the WFD receiving device 100B unicasts a search response to the WFD transmitting device 100A (S303). The WFD transmitting device 100A stores information received in the search response in the information management unit 106A. The information received in the search response includes the IP address information and the port number information of the WFD receiving device 100B.

Next, the search control unit 103A gives a command to the P2P search unit 105A to start a search using P2P. The P2P search unit 105A included in the WFD transmitting device 100A transmits a probe request to the WFD receiving device 100B (S304).

On receipt of an inquiry made by the probe request, the P2P search unit 105B of the WFD receiving device 100B performs a P2P search response process (S305). Specifically, if the WFD receiving device 100B is already connected to the AP 300 in the infrastructure mode, the P2P search unit 105B extends WFD IE and adds information, namely, the IP address information and the port number information of the WFD receiving device 100B. If the WFD receiving device 100B is not connected to the AP 300 in the infrastructure mode, the P2P search unit 105B does not extend WFD IE.

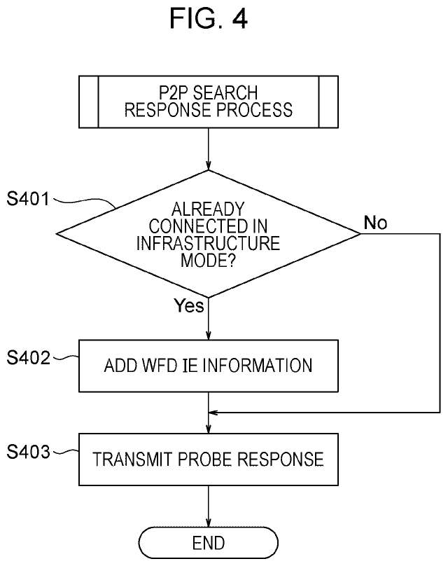

The P2P search unit 105B transmits, as a probe response, WFD IE to which the IP address information and the port number information of the WFD receiving device 100B are added (or not added) to the WFD transmitting device 100A (S306). The WFD transmitting device 100A stores information received in the probe response in the information management unit 106A. At this time, if information is included in the extension target area of WFD IE, the WFD transmitting device 100A also stores the information in the information management unit 106A. A P2P search response process will be described later using FIG. 4.

The connection selecting unit 107A selects, on the basis of the results of the mDNS search and the P2P search, whether to connect to the WFD receiving device 100B over either an infrastructure mode connection or a P2P connection (S307). In the present embodiment, in S307, if both an infrastructure mode connection and a P2P connection are possible, the connection selecting unit 107A preferentially selects an infrastructure mode connection. Note that the user may select whether to use an infrastructure mode connection or a P2P connection on the UI screen of the input unit 152A. Alternatively, the connection selecting unit 107A may refer to a connection log and automatically select the same connection as the last connection. In addition, when establishing a plurality of connections as in multi-source or multi-sink, the connection selecting unit 107A may select an infrastructure mode connection.

On the basis of the selection made by the connection selecting unit 107A, the WFD transmitting device 100A connects to the WFD receiving device 100B and starts streaming communication (S308). When streaming communication is started, the WFD receiving device 100B receives a streaming image (video data) transmitted from the WFD transmitting device 100A. The display control unit 108B of the WFD receiving device 100B controls the streaming image and displays the streaming image on the display unit 153B.

When the connection selecting unit 107A has obtained information necessary for establishing an infrastructure mode connection as a result of a search conducted by the mDNS search unit 104A, it is not always necessary for the P2P search unit 105A to conduct a search, which will be described later. That is, when the mDNS search unit 104A successfully obtains desired search information, that is, information necessary for establishing an infrastructure mode connection, the P2P search unit 105A need not search for the WFD receiving device 100B. In this case, a P2P search process (FIG. 3) is performed only when an mDNS search fails.

A search (S302 and S303) conducted by the mDNS search unit 104A and a search (S304 to S306) conducted by the P2P search unit 105A can be performed in a random order, and either search may be performed first. When a search in S304 to S306 is performed first, if the P2P search unit 105A obtains information necessary for establishing an infrastructure mode connection, a search in S302 and S303 need not be performed.

### About P2P Search Response Process

Next, processing in S305 of FIG. 3 will be described in detail. FIG. 4 is a flowchart for describing a process of transmitting, in response to a probe request received by the WFD receiving device 100B from the WFD transmitting device 100A, a probe response from the P2P search unit 105B.

On receipt of a probe request from the WFD transmitting device 100A, the P2P search unit 105B determines whether the WFD receiving device 100B is already connected to the AP 300 in the infrastructure mode (S401).

If the WFD receiving device 100B is already connected to the AP 300 in the infrastructure mode (YES in S401), the process proceeds to S402. In S402, the P2P search unit 105B extends WFD IE in order to report the IP address information and the port number information used in a connection request for an infrastructure mode connection, and adds the IP address information and the port number information of the WFD receiving device 100B. After S402, the process proceeds to S403.

If the WFD receiving device 100B is not connected to the AP 300 in the infrastructure mode (NO in S401), the process proceeds to S403.

In S403, the P2P search unit 105B transmits a probe response to the WFD transmitting device 100A.

### About Extension of WFD IE

FIG. 5 is a diagram illustrating an example of the format of WFD IE. If the WFD receiving device 100B is already connected in the infrastructure mode when the WFD receiving device 100B transmits a probe response to the WFD transmitting device 100A, a portion of the WFD IE format is extended in order to add the IP address information and the port number information. This portion will be described.

The IP address information is added to, for example, Local IP Address 501, which is WFD Subelement ID No. 8. The port number information used in an infrastructure mode connection does not exist in the existing WFD IE; WFD R2 Device Information 502, which is WFD Subelement ID No. 11, is extended and the port number information is added there.

When adding the IP address information and the port number information, the WFD receiving device 100B may extend WFD Subelement ID Nos. 12 to 255, which correspond to Reserved 503, and may add the information there.

### About Connection Selecting Process

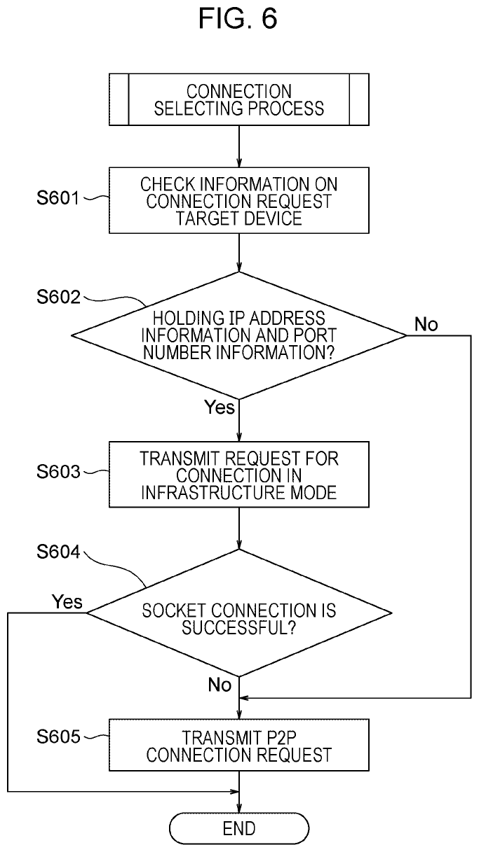

Processing in S307 of FIG. 3 will be described in detail. FIG. 6 is a flowchart for describing a connection selecting process performed by the connection selecting unit 107A. The description with reference to FIG. 6 assumes that an infrastructure mode connection is preferentially selected.

The connection selecting unit 107A of the WFD transmitting device 100A refers to information in the information management unit 106A, which stores information on another device that has responded to searches conducted by the mDNS search unit 104A and the P2P search unit 105A, and checks information on the WFD receiving device 100B (S601). That is, the connection selecting unit 107A checks information on the WFD receiving device 100B, which is a connection request target device.

The connection selecting unit 107A determines whether the IP address information and the port number information of the WFD receiving device 100B are stored in the information management unit 106A (S602). That is, the connection selecting unit 107A determines whether the WFD receiving device 100B is holding the IP address information and the port number information as connection information. In other words, the connection selecting unit 107A determines whether a probe response obtained by the P2P search unit 105A (S306) includes the IP address information and the port number information of the WFD receiving device 100B.

If the determination result obtained in S602 is YES, that is, if the WFD receiving device 100B is holding the IP address information and the port number information, the WFD transmitting device 100A sends a request for connection in the infrastructure mode to the WFD receiving device 100B (S603).

The connection selecting unit 107A determines whether a socket connection was successful (S604). That is, the connection selecting unit 107A determines whether a connection in the infrastructure mode was established.

If no connection was established within a certain period of time as a result of a request for connection in the infrastructure mode (NO in S604), the connection selecting unit 107A sends a request for connection using P2P to the WFD receiving device 100B (S605). Then, the connection selecting unit 107A ends the connection selecting process.

If a connection was established in the infrastructure mode in S604, the connection selecting unit 107A ends the connection selecting process.

If the WFD receiving device 100B is not holding the IP address information and the port number information in S602, the process proceeds to S605, and the connection selecting unit 107A sends a request for P2P connection to the WFD receiving device 100B.

### Advantageous Effects of Embodiment

Due to the network environment of the WFD transmitting device 100A and the WFD receiving device 100B, the WFD transmitting device 100A may sometimes not be able to find the WFD receiving device 100B by conducting an mDNS search. In such a case, the WFD receiving device 100B in the present embodiment extends WFD IE in a P2P search, adds IP address information and port number information, and transmits the information to the WFD transmitting device 100A. Therefore, even if the WFD transmitting device 100A is unable to find the WFD receiving device 100B by conducting an mDNS search, the WFD transmitting device 100A is still able to connect to the WFD receiving device 100B in the infrastructure mode.

That is, even if the WFD receiving device 100B is not found by an mDNS search because the WFD receiving device 100B belongs to a different subnet and accordingly no streaming communication is started, the WFD transmitting device 100A is still able to obtain information necessary for establishing a WFD session with the WFD receiving device 100B by conducting a P2P search. Using the obtained information, the WFD transmitting device 100A is able to establish a WFD session, that is, an infrastructure mode connection, and start streaming communication with the WFD receiving device 100B.

Even when it is selected to send a request for connection in the infrastructure mode (S603), if no video data is transmitted to the WFD receiving device 100B within a certain period of time (NO in S604), video data may be transmitted to the WFD receiving device 100B using a connection mode that was not selected (S605).

Although the WFD transmitting device 100A conducts a search in the above-described embodiment, the WFD receiving device 100B may conduct a search. The same advantageous effects as those described above may be achieved even with a plurality of WFD transmitting devices 100A and a plurality of WFD receiving devices 100B.

### Exemplary Applications

Next, specific exemplary applications of the WFD transmitting device 100A and the WFD receiving device 100B will be described.

Specific examples of the WFD transmitting device 100A include, for example, a PC and a mobile terminal (e.g., smartphone or the like). Specific examples of the WFD receiving device 100B include a projector and a printer. Hereinafter, it is assumed that the WFD transmitting device 100A is a PC, and the WFD receiving device 100B is a projector.

In a security-conscious environment, such as a company, a core network and a terminal network, such as a conference room, may sometimes be managed by different network addresses. In that case, because the PC, which is the WFD transmitting device 100A, and the projector, which is the WFD receiving device 100B, belong to different subnetworks, they may not be searched for by an infrastructure mode search using mDNS. Therefore, the search process (FIG. 3) of the present embodiment is applied to enable the PC to obtain information necessary for infrastructure mode connection by conducting a P2P search, thereby establishing a connection in the infrastructure mode.

In the case of performing streaming communication from a single PC to a plurality of projectors (main venue, satellite venue, and so forth), the use of wireless P2P connection may disrupt communication between devices when a device serving as a GO leaves a network. Compared with an infrastructure mode connection, which is already connected to a network, it is necessary to start from establishing a P2P group, which means that there is a long waiting time before streaming communication is started. Therefore, the search process (FIG. 3) of the present embodiment is applied to enable the PC to obtain information necessary for infrastructure mode connection by conducting a P2P search. In the case of performing streaming communication with a plurality of projectors, a single PC is able to perform streaming communication with a plurality of projectors over an infrastructure mode connection.

The search process of the present embodiment is similarly applicable as above when the WFD transmitting device 100A is a mobile terminal and the WFD receiving device 100B is a projector. In addition, the search process of the present embodiment is similarly applicable as above when the WFD transmitting device 100A is a mobile terminal and the WFD receiving device 100B is a printer.

In an embodiment where the WFD transmitting device 100A is a PC or a mobile terminal and the WFD receiving device 100B is a projector or a printer, information necessary for infrastructure mode connection may be obtained by a P2P search, thereby establishing an infrastructure mode connection. This enhances the convenience for the user.

Note that the specific examples of the WFD transmitting device 100A are not limited to a PC and a mobile terminal, and the specific examples of the WFD receiving device 100B are not limited to a projector and a printer.

### Modifications

Although the connection selecting unit 107A included in the WFD transmitting device 100A performs the connection selecting process described with reference to FIG. 6 in the above-described embodiment, the connection selecting process is not limited to the process illustrated in FIG. 6. For example, the connection selecting unit 107A may select the method of connecting to the WFD receiving device 100B (infrastructure mode connection or wireless P2P connection) using the following scheme.

(1) Let the User Select the Connection Method on the UI Screen.

If the WFD receiving device 100B is holding the IP address information and the port number information (YES in S602 in FIG. 6), the display unit 153A displays the UI screen to let the user select either an infrastructure mode connection or a wireless P2P connection. The WFD transmitting device 100A transmits a connection request to the WFD receiving device 100B using the selected connection method. If no connection was established with the WFD receiving device 100B within a certain period of time as a result of a connection request using the connection method selected by the connection selecting unit 107A (the same as NO in S604 in FIG. 6), a connection request is transmitted using a connection method that was not selected by the user.

(2) Select the Connection Method in Accordance with a Connection Log.

If the WFD receiving device 100B is holding the IP address information and the port number information (YES in S602), the WFD transmitting device 100A checks, for example, whether there is a connection log in the memory 155. If there is a connection log in the memory 155 as a result of the checking, the WFD transmitting device 100A selects, for example, a connection method selected in the last connection log, and transmits a connection request to the WFD receiving device 100B. If a connection was established as a result of a connection request using the selected connection method, the WFD transmitting device 100A stores the selected connection method as part of the connection log in the memory 155.

(3) Select the Connection Method in Accordance with a Connection Form.

The WFD transmitting device 100A selects the connection method in accordance with a connection form for establishing multiple connections, such as multi-source or multi-sink. In this case, an infrastructure mode connection is preferentially selected on certain conditions, such as that the fact that multiple connections are to be established is known in advance, that there is another WFD session when establishing a WFD session, and that the connection destination is one of destinations used in the last multiple connections. If the WFD receiving device 100B is holding the IP address information and the port number information (YES in S602), the WFD transmitting device 100A checks the status of establishing a WFD session, and, if one or more of the certain conditions are satisfied, selects an infrastructure mode connection and transmits a connection request.

(4) Select the Connection Method in Accordance with the Power Connection Status of the WFD Transmitting Device 100A.

If the WFD receiving device 100B is holding the IP address information and the port number information, the WFD transmitting device 100A checks the power connection status of the WFD transmitting device 100A. If the WFD transmitting device 100A is not connected to power as a result of checking the power connection status, the WFD transmitting device 100A selects an infrastructure mode connection and transmits a connection request.

(5) Select the Connection Method in Accordance with the Role of the WFD Transmitting Device 100A in a Wireless P2P Connection.

If the WFD receiving device 100B is holding the IP address information and the port number information, the WFD transmitting device 100A checks its role in a wireless P2P connection. If an intent value indicating the GO degree of priority of the WFD transmitting device 100A is the upper limit value or if the WFD transmitting device 100A serves as a GO as a result of performing a GO negotiation, the WFD transmitting device 100A selects an infrastructure mode connection and transmits a connection request.

### Other Embodiments

Some embodiment(s) can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that various embodiments are not limited to the disclosed exemplary embodiments. The scope of the following claims is to be accorded the broadest interpretation so as to encompass all such modifications and equivalent structures and functions.

This application claims priority to Japanese Patent Application No. 2018-223219, which was filed on Nov. 29, 2018 and which is hereby incorporated by reference herein in its entirety.

What is claimed is:

1. A communication device comprising:
a first obtaining unit that searches for another communication device that does not belong to a wireless network to which the communication device belongs without using an access point of the wireless network, and obtains first search information for establishing a connection in a first connection mode or a second connection mode different from the first connection mode;
a second obtaining unit that searches for said another communication device via the access point of the wireless network, and obtains second search information for establishing a connection in the second connection mode;
a first connection unit that establishes a connection in the first connection mode with said another communication device without using the access point of the wireless network;
a second connection unit that establishes a connection in the second connection mode with said another communication device via the access point of the wireless network; and
a selecting unit that selects the first connection unit or the second connection unit based on at least one of the first search information and the second search information.

2. The communication device according to claim 1, further comprising:
a determination unit that determines whether the first search information obtained by the first obtaining unit includes information for establishing a connection in the second connection mode,
wherein the selecting unit selects the first connection unit or the second connection unit in accordance with a determination result obtained by the determination unit.

3. The communication device according to claim 2, wherein, in a case where the second search information is not obtained by the second obtaining unit, the determination unit determines whether the first search information obtained by the first search unit includes information for establishing a connection in the second connection mode.

4. The communication device according to claim 1, wherein, in a case where the first search information obtained by the first obtaining unit includes information for establishing a connection in the second connection mode, the second obtaining unit does not search for said another communication device.

5. The communication device according to claim 1, wherein, in a case where the second search information is obtained by the second obtaining unit, the first obtaining unit does not search for said another communication device.

6. The communication device according to claim 1, wherein the selecting unit selects the first connection unit or the second connection unit in accordance with a log of connection with said another communication device.

7. The communication device according to claim 1, wherein the selecting unit selects the second connection unit in preference to the first connection unit in a case where there is a plurality of said another communication devices.

8. The communication device according to claim 1, wherein the selecting unit selects the first connection unit or the second connection unit in accordance with a power connection status of the communication device.

9. The communication device according to claim 1, wherein the selecting unit selects the first connection unit or the second connection unit in accordance with a role of the communication device in the first connection mode.

10. The communication device according to claim 1, wherein the selecting unit selects the second connection unit in a case where a connection in the first connection mode and a connection in the second connection mode are possible.

11. The communication device according to claim 1, wherein, in a case where a connection unit selected by the selecting unit is unable to establish a connection with said another communication device within a certain period of time, the communication device establishes a connection with said another communication device using a connection unit not selected by the selecting unit.

12. The communication device according to claim 1, wherein the communication device transmits video data using Miracast (registered trademark) technology to said another communication device connected by the first connection unit or the second connection unit.

13. A communication device comprising:
a first connection unit that establishes a connection in a first connection mode with another communication device that does not belong to a wireless network to which the communication device belongs without using an access point of the wireless network;
a second connection unit that establishes a connection with said another communication device in a second connection mode different from the first connection mode via the access point of the wireless network; and
a transmitting unit that, in a case of responding to a search received from said another communication device without using the access point of the wireless network, transmits information for establishing a connection in the second connection mode to said another communication device.

14. The communication device according to claim 13, wherein the transmitting unit transmits information for establishing a connection in the second connection mode to said another communication device in accordance with a connection status between the access point of the wireless network and the communication device.

15. The communication device according to claim 14, wherein the transmitting unit transmits information for establishing a connection in the second connection mode to said another communication device in a case where the access point of the wireless network and the communication device are connected in the second connection mode.

16. The communication device according to claim 13, wherein the transmitting unit adds information for establishing a connection in the second connection mode to an information element of Wi-Fi Display and transmits the information element to which the information is added to said another communication device.

17. The communication device according to claim 13, wherein information for establishing a connection in the second connection mode includes IP address information and port number information of the communication device.

18. The communication device according to claim 13, wherein the communication device receives video data using Miracast (registered trademark) technology from said another communication device.

19. The communication device according to claim 1, wherein a connection in the first connection mode is a wireless P2P connection, and a connection in the second connection mode is an infrastructure mode connection.

20. A method of controlling a communication device, the method comprising:
searching, by the communication device, for another communication device that does not belong to a wireless network to which the communication device belongs without using an access point of the wireless network, and obtaining first search information for establishing a connection in a first connection mode or a second connection mode different from the first connection mode;
searching, by the communication device, for said another communication device via the access point of the wireless network, and obtaining second search information for establishing a connection in the second connection mode;
establishing, by the communication device, a connection in the first connection mode with said another communication device without using the access point of the wireless network;
establishing, by the communication device, a connection in the second connection mode with said another communication device via the access point of the wireless network; and
selecting, by the communication device, a connection in the first connection mode or a connection in the second connection mode based on at least one of the first search information and the second search information.

21. A method of controlling a communication device, the method comprising:
establishing, by the communication device, a connection in a first connection mode with another communication device that does not belong to a wireless network to which the communication device belongs without using an access point of the wireless network;
establishing, by the communication device, a connection with said another communication device in a second connection mode different from the first connection mode via the access point of the wireless network; and
in a case of responding to a search received from said another communication device without using the access point of the wireless network, transmitting, by the communication device, information for establishing a connection in the second connection mode to said another communication device.

22. A computer-readable storage medium storing a program for causing a communication device to execute a control method, the control method comprising:
searching, by the communication device, for another communication device that does not belong to a wireless network to which the communication device belongs without using an access point of the wireless network, and obtaining first search information for establishing a connection in a first connection mode or a second connection mode different from the first connection mode;
searching, by the communication device, for said another communication device via the access point of the wireless network, and obtaining second search information for establishing a connection in the second connection mode;
establishing, by the communication device, a connection in the first connection mode with said another communication device without using the access point of the wireless network;
establishing, by the communication device, a connection in the second connection mode with said another communication device via the access point of the wireless network; and
selecting, by the communication device, a connection in the first connection mode or a connection in the second connection mode based on at least one of the first search information and the second search information.

23. A computer-readable storage medium storing a program for causing a communication device to execute a control method, the control method comprising:
establishing, by the communication device, a connection in a first connection mode with another communication device that does not belong to a wireless network to which the communication device belongs without using an access point of the wireless network;
establishing, by the communication device, a connection with said another communication device in a second connection mode different from the first connection mode via the access point of the wireless network; and
in a case of responding to a search received from said another communication device without using the access point of the wireless network, transmitting, by the communication device, information for establishing a connection in the second connection mode to said another communication device.
